(19) United States
(12) Patent Application Publication
(10) Pub. No.: US 2008/0157730 A1
(43) Pub. Date: Jul. 3, 2008

(54) HIGH-VOLTAGE GENERATION CIRCUIT AND METHOD FOR REDUCING OVERSHOOT OF OUTPUT VOLTAGE

(76) Inventors: Young-Taek Kim, Suwon-si (KR); Byeong-Hoon Lee, Seoul (KR)

Correspondence Address: F. CHAU & ASSOCIATES, LLC, 130 WOODBURY ROAD, WOODBURY, NY, 11797, US

(21) Appl. No.: 11/740,632

(22) Filed: Apr. 26, 2007

(30) Foreign Application Priority Data
Dec. 28, 2006 (KR) 10-2006-0136238

(51) Int. Cl. G05F 1/10

(52) U.S. Cl. 323/234

(57) ABSTRACT

A high-voltage generation circuit used for a non-volatile memory device reduces the overshoot of a high voltage by controlling a current for sensing the high voltage based on the level of the high voltage or by delaying the operation of an oscillator, which generates a clock signal for generating the high voltage, for a predetermined period of time.

### CROSS-REFERENCE TO RELATED PATENT APPLICATION

This application claims the benefit of Korean Patent Application No. 10-2006-0136238, filed on Dec. 28, 2006, in the Korean Intellectual Property Office, the disclosure of which is incorporated herein in its entirety by reference.

### FIELD OF THE INVENTION

The present disclosure relates to a high-voltage generation circuit and, more particularly, to a high-voltage generation circuit and method for reducing overshoot of an output voltage.

### BACKGROUND OF THE INVENTION

NAND flash memory devices, NOR flash memory devices, electrically erasable and programmable read only memory (EEPROM) devices, and the like that include electrically programmable and erasable memory cells, usually use a high voltage higher than a power supply voltage in order to program or erase the memory cells.

In order to reduce the time needed for programming or erasing the memory cells, the time for generating and stabilizing the high voltage should be reduced. When the frequency of a clock signal for generating the high voltage is increased to reduce the time for generating and stabilizing the high voltage, the high voltage can be generated quickly, but there occurs an overshoot in which an output high voltage is temporarily increased to a level higher than a desired level before being stabilized. This overshoot places stress on a memory device, which may cause the failure of the memory device. Moreover, when a current of the regulator for sensing the high voltage, which is used to stabilize the high voltage in order to reduce the overshoot, is increased in order to increase the response speed of the regulator, power consumption is also increased.

FIG. 1 illustrates the structure of a conventional high-voltage generation circuit 100. FIG. 2 is a graph illustrating a high voltage VPP output from the high-voltage generation circuit 100 illustrated in FIG. 1. The high-voltage generation circuit 100 includes a regulator 110, an oscillator 120, and a high-voltage generator 130.

The regulator 110 compares a voltage VC, which is obtained from the high voltage VPP divided by a plurality of voltage dividing resistors Rx and Ry, with a reference voltage Vref and generates an enable signal CS based on a result of the comparison. A current IS of the regulator 110 for sensing the high voltage VPP is determined based on the high voltage VPP and the voltage dividing resistors Rx and Ry. The oscillator 120 generates a clock signal CLK in response to the enable signal CS. The high-voltage generator 130 receives the clock signal CLK and generates and outputs the high voltage VPP corresponding to the clock signal CLK.

The regulator 110 usually reduces the magnitude of the current IS for sensing the high voltage VPP by increasing the resistance of the voltage dividing resistors Rx and Ry in order to accomplish a low-power operation. When the resistance of the plurality of the voltage dividing resistors Rx and Ry is increased, however, the response speed of the regulator 110 is decreased due to an RC delay. Accordingly, the regulator 110 may not properly perform a regulating operation even when the high voltage VPP reaches a target level. In this case, the overshoot of the high voltage VPP occurs.

Referring to FIG. 2, the high voltage VPP continuously increases even after the high voltage VPP reaches a target level VT and, therefore, the overshoot of the high voltage VPP occurs. A time period from a time T1 when the high voltage VPP reaches the target level VT to a time T2 when the overshoot of the high voltage VPP occurs is referred to as a response time of the regulator 110.

Moreover, when the frequency of the clock signal CLK output from the oscillator 120 is increased in order to generate the high voltage VPP and reduce a stabilization time, the speed of the high voltage VPP is also increased. The overshoot of the high voltage, however, VPP is increased even more. The non-ideal overshoot of the high voltage VPP places an unnecessary stress on a memory device and may thus cause the failure of the memory device.

### SUMMARY OF THE INVENTION

Exemplary embodiments of the present invention provide a high-voltage generation circuit and method for preventing non-ideal overshoot of a high voltage.

According to exemplary embodiments of the present invention, there is provided a high-voltage generation circuit including a high-voltage generation unit, a controller, and a regulator. The high-voltage generation unit generates a high voltage through an output terminal in response to an enable signal. The high-voltage generation unit includes an oscillator configured to generate a clock signal in response to the enable signal, and a high-voltage generator configured to generate the high voltage in response to the clock signal.

The controller monitors a level of the high voltage and generates a first control signal based on a result of the monitoring. The regulator controls a high-voltage sensing current for sensing the high voltage in response to the level of the high voltage and the first control signal and generates the enable signal.

The regulator may have a response speed that varies based on the amount of the high-voltage sensing current and includes a current path and a comparator. The current path may be connected between the output terminal and ground, and the high-voltage sensing current varying in response to the first control signal may flow in the current path. The comparator may compare a voltage sensed from a first node included in the current path with a reference voltage and generate the enable signal based on a result of the comparison.

The high-voltage generation circuit may further include a delay circuit configured to delay the enable signal for a predetermined period of time in response to a second control signal that is generated by the controller based on a result of monitoring the level of the high voltage. The high voltage that is output from the high-voltage generation circuit may be used as a program voltage or an erase voltage for a memory cell of a non-volatile memory device.

According to exemplary embodiments of the present invention, there is provided a high-voltage generation method including generating a high voltage through an output terminal in response to an enable signal monitoring a level of the high voltage and generating a first control signal based on a result of the monitoring, and controlling a high-voltage sensing current for sensing the high voltage in response to the level of the high voltage and the first control signal and generating the enable signal.

The steps of controlling the high-voltage sensing current and generating the enable signal may include varying the high-voltage sensing current in response to the first control signal; and comparing a voltage, which is generated based on the varied high-voltage sensing current, with a reference voltage and generating the enable signal based on the comparison result.

The high-voltage generation method may further include monitoring the level of the high voltage and generating a second control signal based on a result of the monitoring, and controlling an increasing speed of the high voltage by delaying the enable signal for a predetermined period of time in response to the second control signal.

### BRIEF DESCRIPTION OF THE DRAWINGS

Exemplary embodiments of the present invention will be understood in more detail from the following descriptions taken in conjunction with the attached drawings in which:

FIG. 1 illustrates the structure of a conventional high-voltage generation circuit;

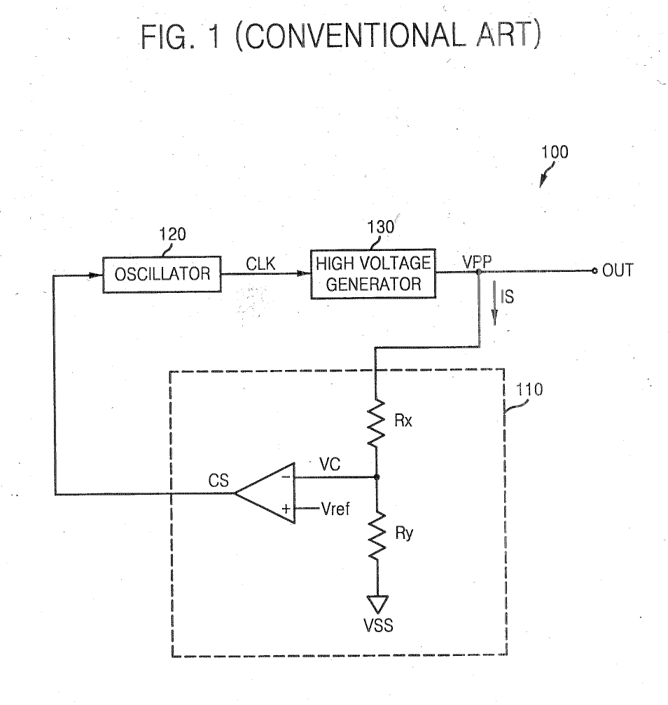

FIG. 2 is a graph illustrating a high voltage that is output from the high-voltage generation circuit illustrated in FIG. 1;

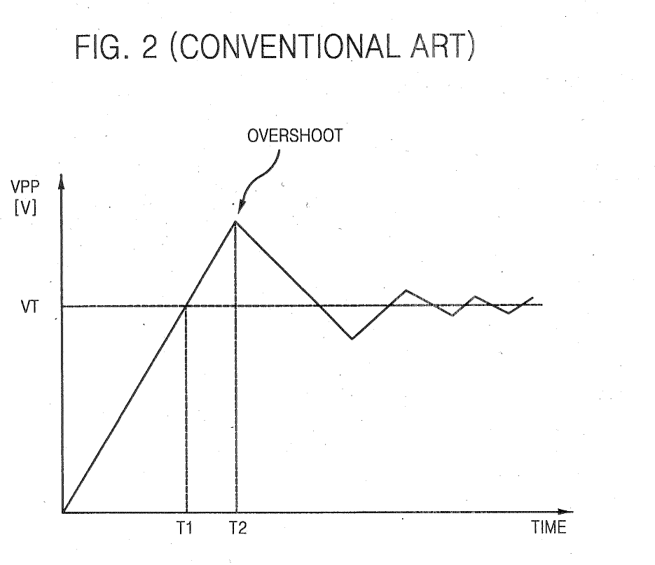

FIG. 3 illustrates the structure of a high-voltage generation circuit according to an exemplary embodiment of the present invention;

FIG. 4 is a graph illustrating a high voltage that is output from the high-voltage generation circuit illustrated in FIG. 3;

FIG. 5 illustrates the structure of a high-voltage generation circuit according to an exemplary embodiment of the present invention; and

FIG. 6 is a graph illustrating a high voltage that is output from the high-voltage generation circuit illustrated in FIG. 5.

### DETAILED DESCRIPTION OF THE EXEMPLARY EMBODIMENTS

Exemplary embodiments of the present invention now will be described more fully hereinafter with reference to the accompanying drawings, in which the exemplary embodiments of the present invention are shown. This invention may, however, be embodied in many different forms and should not be construed as limited to the exemplary embodiments set forth herein. Rather, these exemplary embodiments are provided so that this disclosure will be thorough and complete, and will fully convey the scope of the invention to those of ordinary skill in the art. In the drawings, like numbers refer to like elements throughout.

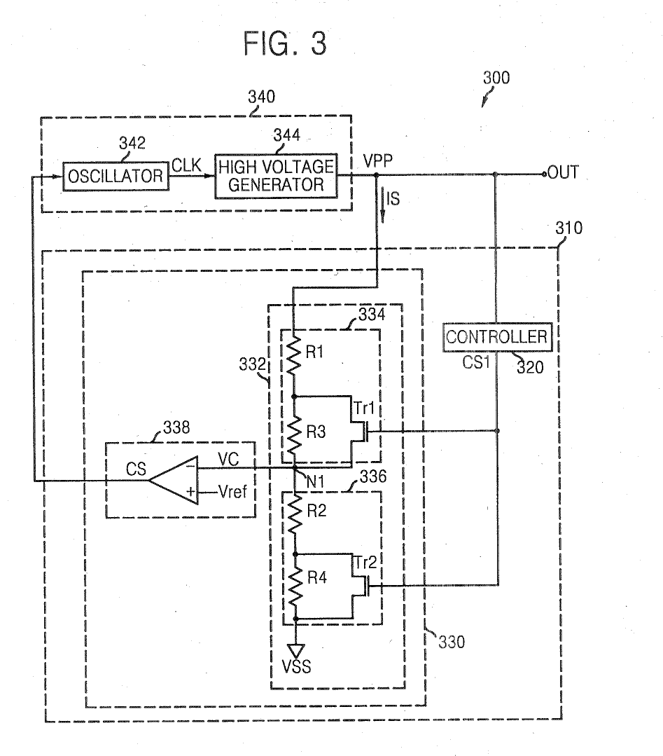

FIG. 3 illustrates the structure of a high-voltage generation circuit 300 according to an exemplary embodiment of the present invention. The high-voltage generation circuit 300 includes a control unit 310 and a high-voltage generation unit 340. The control unit 310 controls a current (hereinafter, referred to a “high-voltage sensing current”) IS for sensing a high voltage VPP in response to a level of the high voltage VPP and generates an enable signal CS. The control unit 310 includes a controller 320 and a regulator 330.

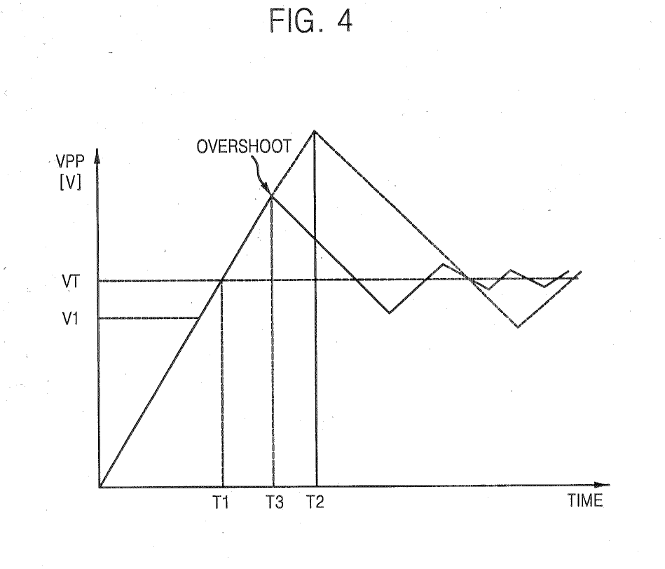

The controller 320 monitors the level of the high voltage VPP and generates a first control signal CS1 based on a monitoring result. The controller 320 may generate the first control signal CS1 at a low level when the high voltage VPP is lower than a first voltage V1 (FIG. 4) and may generate the first control signal CS1 at a high level when the high voltage VPP is higher than the first voltage V1. The first voltage V1 is lower than a target voltage VT (FIG. 4) of the high voltage VPP and is a reference voltage for controlling the high-voltage sensing current IS.

The regulator 330 controls the amount of the high-voltage sensing current IS in response to the level of the high voltage VPP and the first control signal CS1 and generates the enable signal CS. The response speed of the regulator 330 may vary with the high-voltage sensing current IS. The regulator 330 includes a current path 332 and a comparator 338.

The current path 332 is connected between an output terminal OUT outputting the high voltage VPP and ground VSS and has the high-voltage sensing current IS that varies in response to the first control signal CS1. The current path 332 may include a plurality of resistors R1 through R4, which are connected in series between the output terminal OUT and the ground VSS, and one or more switching elements Tr1 and Tr2, each of which is connected in parallel with both ends of one resistor R3 or R4 among the plurality of the resistors R1 through R4 and is switched in response to the first control signal CS1. The current path 332 includes a first variable resistance circuit 334 and a second variable resistance circuit 336.

The first variable resistance circuit 334 is connected between the output terminal OUT and a first node N1 and has a resistance that may vary in response to the first control signal CS1. The first variable resistance circuit 334 includes resistors R1 and R3, which are connected in series between the output terminal OUT and the first node N1, and a transistor Tr1, which is connected in parallel with both ends of one resistor R3. The second variable resistance circuit 336 is connected between the first node N1 and the ground VSS and has a resistance that may vary in response to the first control signal CS1. The second variable resistance circuit 336 includes the resistors R2 and R4, which are connected in series between the first node N1 and the ground VSS, and a transistor Tr2, which is connected in parallel with both ends of one resistor R4. Each of the transistors Tr1 and Tr2 may be implemented by a P-channel metal-oxide-semiconductor field-effect transistor (MOSFET) or an N-channel MOSFET.

In this exemplary embodiment, it is assumed that a voltage (hereinafter, referred to as a “comparison voltage”) VC that is sensed at the first node N1 when the high voltage VPP is equal to the first voltage V1 is the same as a comparison voltage VC that is sensed at the first node N1 when the high voltage VPP is equal to the target voltage VT. Accordingly, a ratio between the resistance of the first variable resistance circuit 334 and the resistance of the second variable resistance circuit 336 varies on the basis of a time when the transistors Tr1 and Tr2 start switching operations.

Each of the first and second variable resistance circuits 334 and 336 may be implemented by a variable resistor having a resistance that varies with the first control signal CS1. Consequently, the controller 320 can control the high-voltage sensing current IS by controlling the resistance of the first variable resistance circuit 334 and the resistance of the second variable resistance circuit 336 in response to the level of the high voltage VPP.

The comparison voltage VC input to the comparator 338 is determined based on the high voltage VPP and the ratio between the resistance of the first variable resistance circuit 334 and the resistance of the second variable resistance circuit 336. The comparator 338 compares the comparison voltage VC with a reference voltage Vref and generates the enable signal CS based on a result of the comparison.

The comparator 338 may output the enable signal CS at a high level when the comparison voltage VC is lower than the reference voltage Vref and may output the enable signal CS at a low level when the comparison voltage VC is higher than the reference voltage Vref. The reverse may be possible according to other exemplary embodiments of the present invention.

The high-voltage generation unit 340 generates the high voltage VPP in response to the enable signal CS and outputs the high voltage VPP through the output terminal OUT. The high voltage VPP may be used as a program voltage or an erase voltage for a non-volatile memory device. The high-voltage generation unit 340 includes an oscillator 342 and a high-voltage generator 344.

The oscillator 342 generates a clock signal CLK in response to the enable signal CS fed thereto. For instance, the oscillator 342 may generate the clock signal CLK when the enable signal is at a high level and may not generate the clock signal CLK when the enable signal CS is at a low level. The reverse may be possible according to exemplary embodiments of the present invention.

The high-voltage generator 344 generates the high voltage VPP corresponding to the clock signal CLK and outputs the high voltage VPP through the output terminal OUT. In other words, the high-voltage generator 344 performs a pumping operation for generating the high voltage VPP only when the oscillator 342 outputs the clock signal CLK.

Hereinafter, a procedure in which the high-voltage generation circuit 300 reduces overshoot of the high voltage VPP by controlling the high-voltage sensing current IS will be described.

When the high voltage VPP is lower than the first voltage V1 shown in FIG. 4, the controller 320 outputs the first control signal CS1 at a low level. As a result, the first and second transistors Tr1 and Tr2 are turned off and the high-voltage sensing current IS has a value obtained by dividing the high voltage VPP by the sum of the resistance values of the resistors R1, R2, R3, and R4. When the high voltage VPP is higher than the first voltage V1, the controller 320 outputs the first control signal CS1 at a high level. As a result, the first and second transistors Tr1 and Tr2 are turned on and the high-voltage sensing current IS has a value obtained by dividing the high voltage VPP by the sum of the resistance values of the first resistors R1 and R2. In this exemplary embodiment, for clarity of the description, the turn-on resistances of the first and second transistors Tr1 and Tr2 are not considered.

Consequently, when the high voltage VPP is higher than the first voltage V1, the high-voltage sensing current IS is increased. In other words, the controller 320 increases the high-voltage sensing current IS when the high voltage VPP reaches the level of the first voltage V1, thereby increasing the response speed (that is, regulating the speed) of the regulator 330. When the response speed of the regulator 330 is increased, a speed at which the oscillator 342 is controlled is also increased. Thus, the high-voltage generation circuit 300 can reduce the overshoot of the high voltage VPP by increasing the speed at which the high voltage VPP is controlled after the high voltage VPP becomes equal to the first voltage V1.

FIG. 4 is a graph illustrating the high voltage VPP that is output from the high-voltage generation circuit 300 illustrated in FIG. 3. In FIG. 4, a solid line indicates the high voltage VPP that is output from the high-voltage generation circuit 300 according to an exemplary embodiment of the present invention, while a dotted line indicates the high-voltage VPP that is output from a conventional high-voltage generation circuit.

Referring to FIG. 4, the overshoot of the high voltage VPP output from the high-voltage generation circuit 300 is reduced as compared to the overshoot generated in the conventional high-voltage generation circuit, and the response time of the regulator 330 is reduced from a period of T1 to T2 to a period of T1 to T3. In addition, the time required for the high voltage VPP to be stabilized is also reduced.

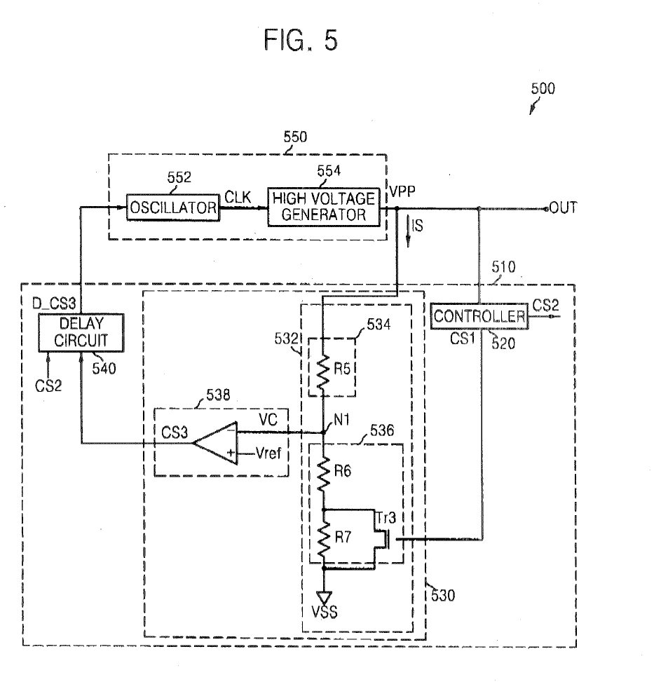

FIG. 5 illustrates the structure of a high-voltage generation circuit 500 according to an exemplary embodiment of the present invention. The high-voltage generation circuit 500 includes a control unit 510 and a high-voltage generation unit 550.

The control unit 510 generates an enable signal D_CS3 that can control the increasing speed or rising rate of a high voltage VPP, in response to the level of the high voltage VPP. The control unit 510 includes a controller 520, a regulator 530, and a delay circuit 540.

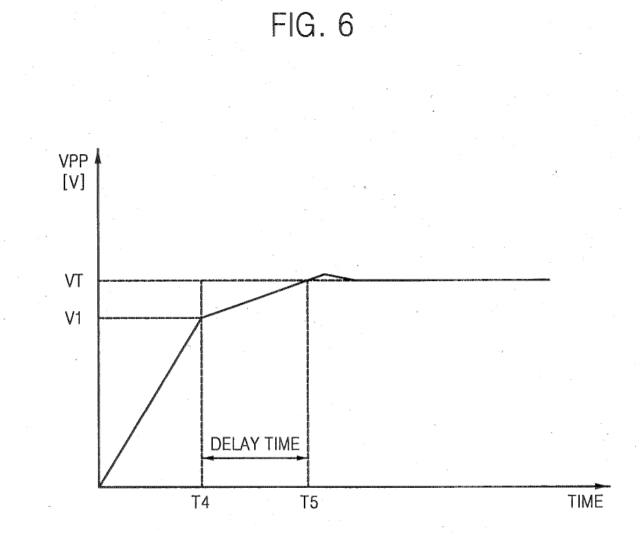

The controller 520 monitors the level of the high voltage VPP and generates a first control signal CS1 and a second control signal CS2. In this exemplary embodiment, the controller 520 may generate the first control signal CS1 at a low level when the high voltage VPP is lower than a first voltage V1 (FIG. 6) and may generate the first control signal CS1 at a high level when the high voltage VPP is higher than the first voltage V1. In addition, the controller 520 may generate the second control signal CS2 at a high level when the high voltage VPP is lower than the first voltage V1 and may generate the second control signal CS2 at a low level when the high voltage VPP is higher than the first voltage V1. The first voltage V1 is lower than a target voltage VT (FIG. 6) of the high voltage VPP and is a reference voltage for determining operation or non-operation of the delay circuit 540.

The regulator 530 controls a high-voltage sensing current IS for sensing the high voltage VPP in response to the level of the high voltage VPP and the first control signal CS1 and generates an enable signal CS3. The regulator 530 includes a current path 532 and a comparator 538. The current path 532 produces a comparison voltage VC in response to the first control signal CS1. The current path 532 includes a first variable resistance circuit 534 and a second variable resistance circuit 536.

The first variable resistance circuit 534 is connected between an output terminal OUT outputting the high voltage VPP and a first node N1. The second variable resistance circuit 536 is connected between the first node N1 and a ground voltage VSS. The resistance of each of the first and second variable resistance circuits 534 and 536 may vary in response to the first control signal CS1. A third transistor Tr3 is included in the second variable resistance circuit 536 and may be implemented by a MOSFET that is turned on or off in response to the first control signal CS1.

The comparison voltage VC that is obtained when the high voltage VPP is equal to the first voltage V1 should be the same as the comparison voltage VC obtained when the high voltage VPP is equal to the target voltage VT. Accordingly, a ratio between the resistance of the first variable resistance circuit 534 and the resistance of the second variable resistance circuit 536 varies on the basis of a time when the third transistor Tr3 starts switching operation.

Each of the first and second variable resistance circuits 534 and 536 could also be implemented by a variable resistor having a resistance that varies in response to the first control signal CS1 and, in any event, the current path 532 performs the same functions as the current path 332 illustrated in FIG. 3.

The comparator 538 compares the level of the comparison voltage VC with the level of a reference voltage Vref and generates the enable signal CS3 based on a result of the comparison. In this exemplary embodiment, the comparator 538 may generate the enable signal CS3 at a low level when the comparison voltage VC is higher than the reference voltage Vref and may generate the enable signal CS3 at a high level when the comparison voltage VC is lower than the reference voltage Vref.

The delay circuit 540 may delay the enable signal CS3 in response to the second control signal CS2 from the controller 520. In this exemplary embodiment, the delay circuit 540 may output the enable signal CS3 after delaying it for a predetermined period of time when the second control signal CS2 is at a low level and may output the enable signal CS3 without delaying it when the second control signal CS2 is at a high level.

The high-voltage generation unit 550 generates the high voltage VPP in response to the enable signal D_CS3 output from the delay circuit 540. The high-voltage generation unit 550 includes an oscillator 552 and a high-voltage generator 554. The oscillator 552 generates a clock signal CLK in response to the enable signal D_CS3 and the high-voltage generator 554 generates the high voltage VPP in response to the clock signal CLK.

Hereinafter, a procedure in which the high-voltage generation unit 550 reduces overshoot of the high voltage VPP by controlling the increasing speed or rising rate of the high voltage VPP will be described.

When the high voltage VPP is lower than the first voltage V1, the controller 520 generates the second control signal CS2 at the high level. Since the comparison voltage VC sensed from the first node N1 of the current path 532 is lower than the reference voltage Vref, the comparator 538 outputs the enable signal CS3 at the high level. Since the second control signal CS2 is at the high level, the delay circuit 540 outputs the enable signal CS3 at the high level. The oscillator 552 outputs the clock signal CLK in response to the enable signal CS3 at the high level and the high voltage generator 554 generates the high voltage VPP in response to the clock signal CLK.

When the high voltage VPP is higher than the first voltage V1, however, the controller 520 generates the second control signal CS2 at the low level. Even if the comparator 538 outputs the enable signal CS3 at the high level, since the second control signal CS2 is at the low level, the delay circuit 540 outputs the enable signal D_CS3 by delaying the enable signal CS3 at the high level for the predetermined period of time. At this time, the oscillator 552 does not generate the clock signal CLK for the predetermined period of time. Accordingly, the high-voltage generator 554 does not perform the pumping operation for generating the high voltage VPP. At this time, the high voltage VPP reaches the target voltage VT through free elevation from the first voltage V1 and, therefore, the overshoot of the high voltage VPP rarely occurs.

FIG. 6 is a graph illustrating the high voltage VPP that is output from the high-voltage generation circuit 500 illustrated in FIG. 5. Referring to FIG. 6, the increasing speed or rising rate of the high voltage VPP that is output from the high-voltage generation circuit 500 slows down for a predetermined period of time T4 to T5(DELAY TIME) after the high voltage VPP reaches the first voltage V1. Accordingly, as compared to the conventional high-voltage generation circuit, the high-voltage generation circuit 500 according to an exemplary embodiment of the present invention reduces the overshoot of the high voltage VPP and also reduces time taken to stabilize the high voltage VPP.

As described above, according to exemplary embodiments of the present invention, a high-voltage generation circuit reduces the overshoot of a high voltage by controlling a current for sensing the high voltage based on the level of the high voltage or by delaying the operation of an oscillator generating the high voltage for a predetermined period of time.

While the present invention has been shown and described with reference to exemplary embodiments thereof, it will be understood by those of ordinary skill in the art that various changes in form and detail may be made herein without departing from the spirit and scope of the present invention, as defined by the following claims.

What is claimed is:

1. A high-voltage generation circuit comprising:
a high-voltage generation unit configured to generate a high voltage through an output terminal in response to an enable signal;
a controller configured to monitor a level of the high voltage and to generate a first control signal based on a result of the monitoring; and
a regulator configured to control a high-voltage sensing current for sensing the high voltage in response to the level of the high voltage and the first control signal and to generate the enable signal.

2. The high-voltage generation circuit of claim 1, wherein the regulator has a response speed that varies based on an amount of the high-voltage sensing current.

3. The high-voltage generation circuit of claim 1, wherein the regulator comprises:
a current path that is connected between the output terminal and ground and through which flows the high-voltage sensing current varying in response to the first control signal; and
a comparator configured to compare a voltage sensed from a first node included in the current path with a reference voltage and to generate the enable signal based on a result of the comparison.

4. The high-voltage generation circuit of claim 3, wherein the current path comprises:
a plurality of resistors connected in series between the output terminal and the ground; and
at least one switching element that is connected in parallel with both ends of at least one of the plurality of resistors and that is switched in response to the first control signal.

5. The high-voltage generation circuit of claim 4, wherein the switching element is a metal-oxide semiconductor field-effect transistor (MOSFET).

6. The high-voltage generation circuit of claim 3, wherein the current path comprises:
a first variable resistor that is connected between the output terminal and the first node and that has a resistance varying in response to the first control signal; and
a second variable resistor that is connected between the first node and the ground and that has a resistance that varies in response to the first control signal.

7. The high-voltage generation circuit of claim 1, wherein the high-voltage generation unit comprises:
an oscillator configured to generate a clock signal in response to the enable signal; and
a high-voltage generator configured to generate the high voltage in response to the clock signal.

8. The high-voltage generation circuit of claim 7, further comprising a delay circuit configured to delay the enable signal for a predetermined period of time in response to a second, control signal that is generated by the controller based on a result of monitoring the level of the high voltage.

9. The high-voltage generation circuit of claim 8, wherein a speed of increase of the high voltage varies based on the second control signal.

10. A high-voltage generation method comprising:
generating a high voltage through an output terminal in response to an enable signal;
monitoring a level of the high voltage and generating a first control signal based on a result of the monitoring; and
controlling a high-voltage sensing current for sensing the high voltage in response to a level of the high voltage and the first control signal and generating the enable signal.

11. The high-voltage generation method of claim 10, wherein the step of controlling the high-voltage sensing current and generating the enable signal comprises:
varying the high-voltage sensing current in response to the first control signal; and
comparing a voltage that is generated based on the varied high-voltage sensing current with a reference voltage and generating the enable signal based on a comparison result.

12. The high-voltage generation method of claim 10, wherein the step of generating the high voltage through the output terminal in response to the enable signal comprises:
generating a clock signal in response to the enable signal; and
generating the high voltage in response to the clock signal.

13. The high-voltage generation method of claim 12, further comprising:
monitoring the level of the high voltage and generating a second control signal based on a result of the monitoring; and
controlling a speed of increase of the high voltage by delaying the enable signal for a predetermined period of time in response to the second control signal.

14. The high-voltage generation method of claim 10, further comprising using the high-voltage from the output terminal as one of a program voltage and an erase voltage for a memory cell of a non-volatile memory device.

15. A high-voltage generation method comprising:
generating a high voltage in response to an enable signal output from a regulator; and
comparing the high voltage with a predetermined voltage and controlling a response speed of the regulator based on a result of the comparison.

16. The high-voltage generation method of claim 15, further comprising:
comparing the high voltage with a predetermined voltage and delaying the enable signal output from the regulator for a predetermined period of time based on a result of the comparison; and
generating the high voltage in response to the delayed enable signal.
